(19) United States
(12) Patent Application Publication
(10) Pub. No.: US 2016/0009266 A1
(43) Pub. Date: Jan. 14, 2016

(54) BRAKING FLUID CONTROL APPARATUS

(71) Applicants: DENSO CORPORATION, Kariya-city (JP); ADVICS CO., LTD., Kariya-city (JP)

(72) Inventor: Yoshitada Katayama, Handa-shi (JP)

(21) Appl. No.: 14/750,134

(22) Filed: Jun. 25, 2015

(30) Foreign Application Priority Data
Jul. 10, 2014 (JP) 2014-142493

(51) Int. Cl. B60T 15/02; F16K 31/06

(52) U.S. Cl. CPC B60T 15/028; F16K 31/06

(57) ABSTRACT

A braking fluid control apparatus includes a housing and an electromagnetic valve. The housing includes a fluid passage through which a braking fluid flows, and is formed with an assembling hole which opens to outside of the housing at an open end thereof. The electromagnetic valve includes a cylindrical sleeve inserted in the assembling hole. The sleeve includes a disk-shaped flange part projecting radially outward thereof. The flange part is formed by bending work in a convex shape projecting toward the bottom portion of the assembling hole, and disposed within the assembling hole. The flange part is sandwiched between the bottom portion of the assembling hole and a swaging deformation portion formed by swaging an area in the vicinity of the open end of the assembling hole.

This application claims priority to Japanese Patent Application No. 2014-142493 filed on Jul. 10, 2014, the entire contents of which are hereby incorporated by reference.

### BACKGROUND OF THE INVENTION

1. Field of the Invention

The present invention relates to a braking fluid control apparatus.

2. Description of Related Art

Japanese Patent No. 4147645 describes a braking fluid control apparatus having a structure in which a fluid passage through which a braking fluid flows is formed in a housing, and the fluid passage is opened and closed by an electromagnetic valve.

The electromagnetic valve includes a sleeve that houses a plunger, the plunger being formed with a disk-shaped flange part projecting axially outward of the sleeve. After the flange part is inserted into an assembling hole of the housing, a portion in the vicinity of the opening of the assembling hole is swaged to be deformed so that the flange part is sandwiched between the deformed portion and the bottom portion of the assembling hole.

Further, a wedge portion or a groove portion is formed in the flange part so that the contact pressure in the contact surface with the housing increases to thereby increase the sealability.

However, the above braking fluid control apparatus has a problem in that it is difficult to form the wedge portion or groove portion in the flange part by bending work. If the wedge portion or groove portion is formed in the flange part by press forming, since the forming accuracy is unstable, the sealability is unstable.

### SUMMARY

An exemplary embodiment provides a braking fluid control apparatus comprising:

a housing; and

an electromagnetic valve,

the housing including a fluid passage through which a braking fluid flows, and being formed with an assembling hole which opens to outside of the housing at an open end thereof and has a flat bottom portion,

the electromagnetic valve including:

a cylindrical sleeve inserted in the assembling hole on a side of one end portion thereof;

a coil disposed at an outer periphery of the sleeve on a side of another end portion of the sleeve;

a plunger disposed within the sleeve so as to be movable depending on energization of the coil; and

a valve body for opening and closing the fluid passage in interlock with movement of the plunger,

the sleeve including a disk-shaped flange part projecting radially outward thereof from the side of the one end portion of the sleeve,

the flange part being formed by bending work in a convex shape projecting toward the bottom portion of the assembling hole or a concave shape concaved toward the bottom portion of the assembling hole over an entire periphery thereof, and disposed within the assembling hole,

the flange part being sandwiched between the bottom portion of the assembling hole and a swaging deformation portion formed by swaging an area in the vicinity of the open end of the assembling hole.

Another exemplary embodiment provides a braking fluid control apparatus comprising:

a housing; and

an electromagnetic valve,

the housing including a fluid passage through which a braking fluid flows, and formed with an assembling hole which opens to outside of the housing at an open end thereof and has a flat bottom portion,

the electromagnetic valve including:

a cylindrical valve seat section inserted in the assembling hole on a side of one end portion thereof, and formed with a valve seat at a bottom portion thereof;

a cylindrical sleeve inserted in the valve seat section on a side of one end portion thereof;

a coil disposed at an outer periphery of the sleeve on a side of another end portion of the sleeve;

a plunger disposed within the sleeve so as to be movable depending on energization of the coil; and

a valve body that opens and closes the fluid passage by sitting on and separating from the valve seat in interlock with movement of the plunger,

the valve seat section including a disk-shaped flange part projecting radially outward thereof from the side of the one end portion thereof,

the flange part being formed by bending work in a convex shape projecting toward the bottom portion of the assembling hole or a concave shape concaved toward the bottom portion of the assembling hole over an entire periphery thereof, and disposed within the assembling hole,

the flange part being sandwiched between the bottom portion of the assembling hole and a swaging deformation portion formed by swaging an area in the vicinity of the open end of the assembling hole.

According to each of the exemplary embodiments, there is provided a braking fluid control apparatus having excellent sealability which is easy to manufacture by press forming.

Other advantages and features of the invention will become apparent from the following description including the drawings and claims.

### BRIEF DESCRIPTION OF THE DRAWINGS

In the accompanying drawings:

FIG. 1 is a sectional view of a braking fluid control apparatus according to a first embodiment of the invention;

FIG. 2 is sectional views of a housing and a sleeve before swaging included in the fluid control apparatus according to the first embodiment of the invention;

FIG. 3 is sectional views of the housing and the sleeve after swaging included in the fluid control apparatus according to the first embodiment of the invention;

FIG. 4 is sectional views of a housing and a sleeve before swaging included in a modification of the fluid control apparatus according to the first embodiment of the invention;

FIG. 5 is sectional views of the housing and the sleeve after swaging of the modification of the fluid control apparatus according to the first embodiment of the invention;

FIG. 6 is a sectional view of a braking fluid control apparatus according to a second embodiment of the invention;

FIG. 7 is a sectional view of a braking fluid control apparatus according to a third embodiment of the invention; and

FIG. 8 is a sectional view of a braking fluid control apparatus according to a fourth embodiment of the invention.

### PREFERRED EMBODIMENTS OF THE INVENTION

In the below described embodiments, the same or equivalent sections, parts or portions are indicated by the same reference numerals.

### First Embodiment

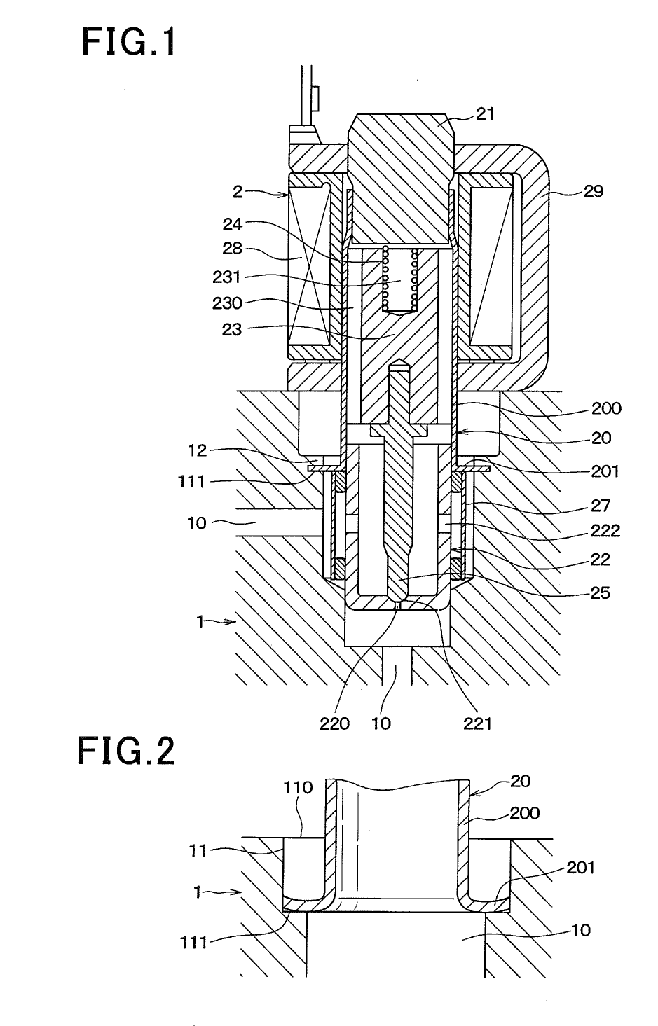

An ABS actuator as a braking fluid control apparatus according to a first embodiment of the invention is described with reference to FIGS. 1 to 5.

As shown in FIG. 1, the ABS actuator includes a housing 1 and an electromagnetic valve 2.

As shown in FIG. 2, the housing 1, which is made of metal such as aluminum, is formed with a fluid passage 10 through which a braking fluid flows, and a cylindrical assembling hole 11 into which a sleeve 20 (described later) of the electromagnetic valve 2 is inserted.

The assembling hole 11 communicates with the fluid passage 10, and opens to the outside of the housing 1 at its opening portion 110. The bottom portion 111 of the assembling hole 11 is flat before swaging.

The electromagnetic valve 2 includes the sleeve 20 to be inserted into the assembling hole 11. The sleeve 20, which is press-formed from non-magnetic material such as stainless steel, includes a cylindrical sleeve body part 200 and a disk-shaped sleeve flange part 201 which projects from one end of the sleeve body part 200 radially outward of the sleeve body part 200. The sleeve flange part 201 is press-bent to have a convex shape projecting toward the bottom portion 111 of the assembling hole 11 over its entire circumferential length. That is, the sleeve flange part 201 is press-bent such that its cross-sectional shape becomes circular.

As shown in FIG. 1, a cylindrical stator core 21 made of magnetic metal is disposed within the end portion on the side opposite to the sleeve flange part 201 of the sleeve body part 200. The sleeve body part 200 and the stator core 21 are joined to each other liquid-tightly by laser welding or the like so that the end portion of the sleeve body part 200 is closed.

A metal-made valve seat section 22, which is press-formed to have a bottomed cylindrical shape, is joined liquid-tightly to the inside of the end portion on the side of the sleeve flange part 201 of the sleeve body part 200 by laser welding or the like. More specifically, the valve seat section 22 is joined to the sleeve body part 200 by welding at its opening portion.

The bottom portion of the valve seat section 22 is formed with a valve seat hole 220 to communicate with the fluid passage 10 of the housing 1 and a valve seat 221 surrounding the valve seat hole 22. The fluid passage 10 is closed or opened by a later described valve body which sits on or separates from the valve seat 221. The valve seat section 22 is formed with a communication hole 222 at its side surface to communicate with the fluid passage 10 of the housing 1.

A cylindrical plunger 23 made of magnetic metal is disposed movably back and forth within the sleeve 20. The plunger 23 is formed with groove portions 230 extending from one end to the other end thereof at its outer peripheral surface.

The plunger 23 is formed with a spring insertion hole 231 on the side of the stator core 21. A spring 24 is inserted in the spring insertion hole 231 to bias the plunger 23 toward the valve seat 221.

A cylindrical valve body 25 is inserted and fixed in a hole formed in the end portion on the side opposite to the stator core 21 of the plunger 23. The valve body 25 sits on or separates from the valve seat 221 to close or open the fluid passage 10 in interlock with the plunger 23.

A filter 27 is mounted on the sleeve 20. The filter 27 is disposed at a position opposite to the communication hole 222 to prevent foreign substance mixed in the braking fluid from entering the electromagnetic valve 2.

A coil 28 which generates a magnetic field when energized (supplied with current) is disposed at the outer periphery of a portion of the sleeve 20, this portion projecting from the housing 1. A yoke 29 made of magnetic metal is disposed so as to surround the coil 28.

The sleeve 20, stator core 21, valve seat section 22, plunger 23, spring 24, valve body 25 and filter 27 are assembled integrally to form a valve section. The valve section is assembled to the housing 1, and then the coil 28 and the yoke 29 are mounted on the sleeve 20. The valve seat section 22 is press-fitted liquid-tightly in the hole of the housing 1.

Next, the operation of the electromagnetic valve 2 having the above described structure is explained. FIG. 2 shows the electromagnetic valve 2 in the state where the coil 28 is not energized. In this state, the plunger 23 is biased toward the valve seat section 22 by the spring 24, the valve body 25 sits on the valve seat 221 to close the valve seat hole 220 so that the fluid passage 10 is closed to prevent passage of the braking fluid.

On the other hand, when the coil 28 is energized to generate a magnetic field, the stator core 21, the plunger 23 and the yoke 29 constitute a magnetic path. In this state, the plunger 24 is attracted to the side of the stator core 21 by the magnetic attraction force against the biasing force of the spring 24, as a result of which the valve body 25 separates from the valve seat 221 causing the valve seat hole 220 to open to allow the braking fluid to flow through the fluid passage 10.

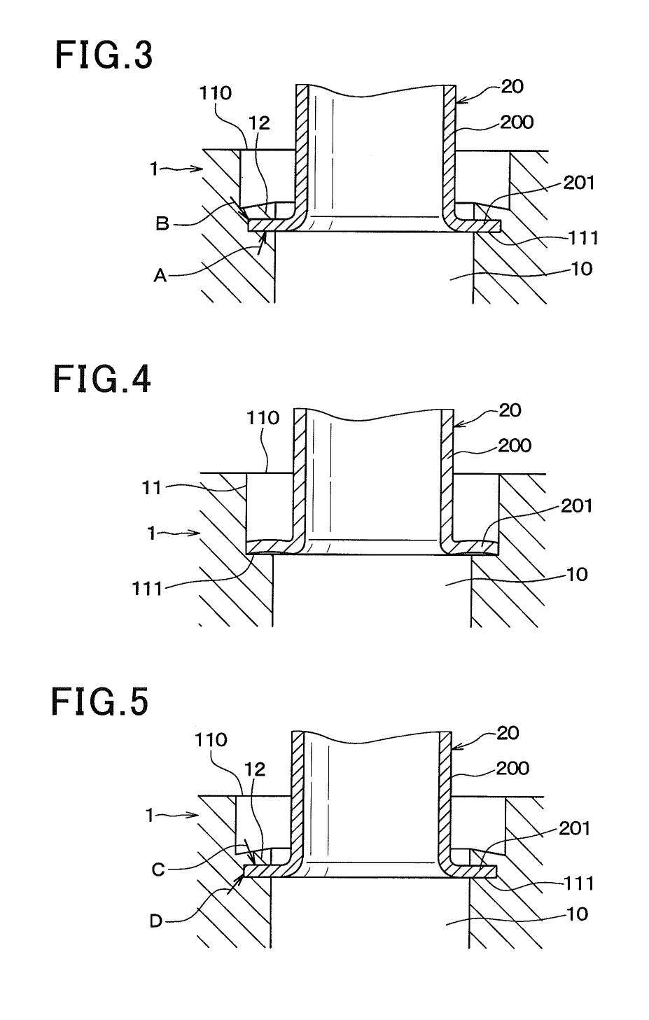

Next, fixing between the valve section and the housing 1, more specifically, between the sleeve 20 and the housing 20 is explained. In FIGS. 2 and 3, the components other than the sleeve 20 of the valve section are omitted from illustration to facilitate understanding.

In the beginning, as shown in FIG. 2, the sleeve 20 is inserted into the assembling hole 11, and the sleeve flange part 201 is caused to abut against the bottom portion 111 of the assembling hole 11.

Next, as shown in FIG. 3, the periphery of the opening portion 110 of the housing 1 is swaged to plastic-deform the housing 1 such that a swaging deformation portion 12 is formed. The sleeve flange part 201 is sandwiched between the swaging deformation portion 12 and the bottom portion 111 of the assembling hole 11.

Since a high contact pressure occurs at the abutment portion A between the top portion of the sleeve flange part 201 and the bottom portion 111 of the assembling hole 11 and at the abutment portion B between the peripheral corner portion of the sleeve flange part 201 and the swaging deformation portion 12, good sealability can be obtained.

Further, since the sleeve flange part 201 is formed in a convex shape by bending work, the press-forming can be performed easily. Further, since the accuracy of pressing forming is stable, the sealability can be increased.

In the above embodiment, the sleeve flange part 201 is press-bent in a convex shape projecting toward the bottom portion 111 of the assembling hole 11. However, as shown in FIGS. 4 and 5, the sleeve flange part 201 may be press-bent in a concave shape concaved toward the bottom portion 111 of the assembling hole 11. In this case, since a high contact pressure occurs at the abutment portion C between the top portion of the sleeve flange part 201 and the swaging deformation portion 12 and at the abutment portion C between the peripheral corner portion of the sleeve flange part 201 and the bottom portion 111 of the assembling hole 11, good sealability can be obtained.

### Second Embodiment

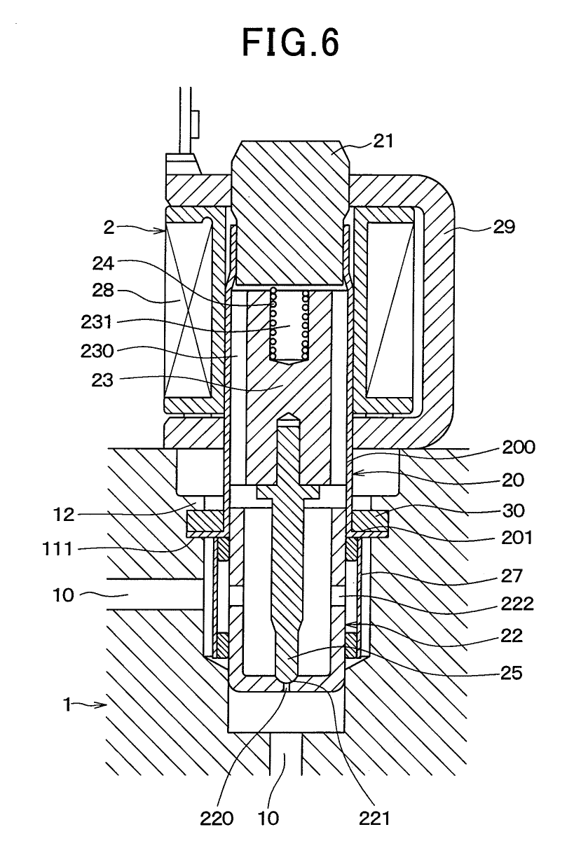

Next, a second embodiment of the invention is described with reference to FIG. 6 with a focus on differences with the first embodiment.

In the braking fluid control apparatus according to the first embodiment, the pressure of the braking fluid acts on the inner periphery of the sleeve flange part 201. Accordingly, if the pressure of the braking fluid is excessively high, there is a concern that the sleeve flange part 201 may be deformed causing the swaging deformation portion 12 to be plastic-deformed, as a result of which the contact pressures at the abutment portion between the sleeve flange part 201 and the bottom portion of the assembling hole 11 and at the abutment portion between the sleeve flange part 201 and the swaging deformation portion 12 may decrease causing the sealability to be lowered.

To deal with such a concern, in the second embodiment, a ring 30 as a deformation suppressing member is sandwiched between the sleeve flange part 201 and the swaging deformation portion 12. The ring 30 is made of metal, and has a plate thickness sufficiently larger than that of the sleeve flange part 201 so that its rigidity is sufficiently high. The ring 30 is formed in a disk shape, and abuts against nearly the entire surface on the side of the outer space of the sleeve flange part 201.

Since the load which the braking fluid acts on the sleeve flange part 201 is received by the ring 30 having high rigidity, the sleeve flange part 201 can be prevented or suppressed from being deformed. Accordingly, since the contact pressure at the abutment portion between the sleeve flange part 201 and the bottom portion 111 of the assembling hole 11 can be prevented or suppressed from decreasing, good sealability can be maintained.

The second embodiment provides the same advantages as those provided by the first embodiment. In addition, since the sleeve flange part 201 can be prevented or suppressed from being deformed, good sealability can be maintained permanently.

### Third Embodiment

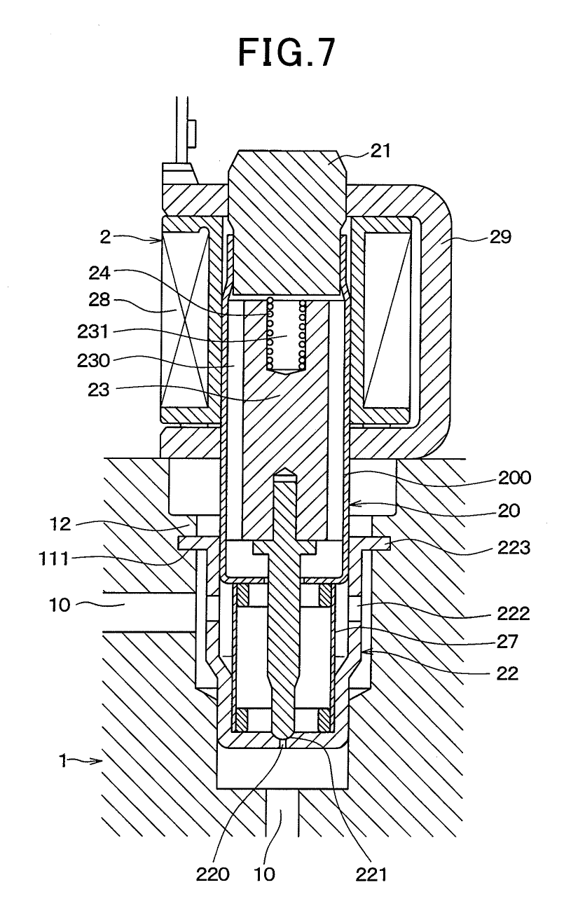

Next, a third embodiment of the invention is described with reference to FIG. 7 with a focus on differences with the first embodiment.

In the third embodiment, the valve seat section 22 includes a disk-shaped valve seat flange part 223 which projects radially outward of the valve seat 22 from the side of its open end. This valve seat flange part 223 is formed by press bending so as to have a convex shape projecting toward the bottom portion 111 of the assembling hole 11 over its entire periphery, that is, so as to have a circular arc shape in cross section.

In this embodiment, the sleeve flange part 201 is eliminated from the sleeve 20. The sleeve 20 is press-fitted in the valve seat section 22, and then joined to the valve seat section 22 by welding.

Next, fixing between the valve section and the housing 1, more specifically between the valve seat section 22 and the housing 1 is explained. First, the valve seat section 22 is inserted into the assembling hole 11 (see FIG. 2), and the valve seat flange part 223 is caused to abut against the bottom portion 111 of the assembling hole 11.

Secondary, the area in the vicinity of the opening portion 110 (see FIG. 2) of the housing 1 is swaged. As a result, the housing 1 is plastic-deformed to form a swaging deformation portion 12, and the valve seat flange part 223 is sandwiched between the swaging deformation portion 12 and the bottom portion 111 of the assembling hole 11.

Since a high contact pressure occurs at the abutment portion between the top portion of the valve seat flange part 223 and the bottom portion 111 of the assembling hole 11 and at the abutment portion between the peripheral corner portion of the valve seat flange part 223 and the swaging deformation portion 12, good sealability can be obtained.

Further, since the valve seat flange part 201 is formed in a convex shape by bending work, the press forming work can be performed easily. Further, since the accuracy of press forming is stable, the sealability can be increased.

In the above embodiment, the valve seat flange part 223 is press-bent in a convex shape projecting toward the bottom portion 111 of the assembling hole 11. However, the valve seat flange part 223 may be press-bent in a concave shape concaved toward the bottom portion 111 of the assembling hole 11. In this case, since a high contact pressure occurs at the abutment portion between the top portion of the valve seat flange 223 and the swaging deformation portion 12 and at the abutment portion between the peripheral corner portion of the valve seat flange part 201 and the bottom portion 111 of the assembling hole 11, good sealability can be obtained.

### Fourth Embodiment

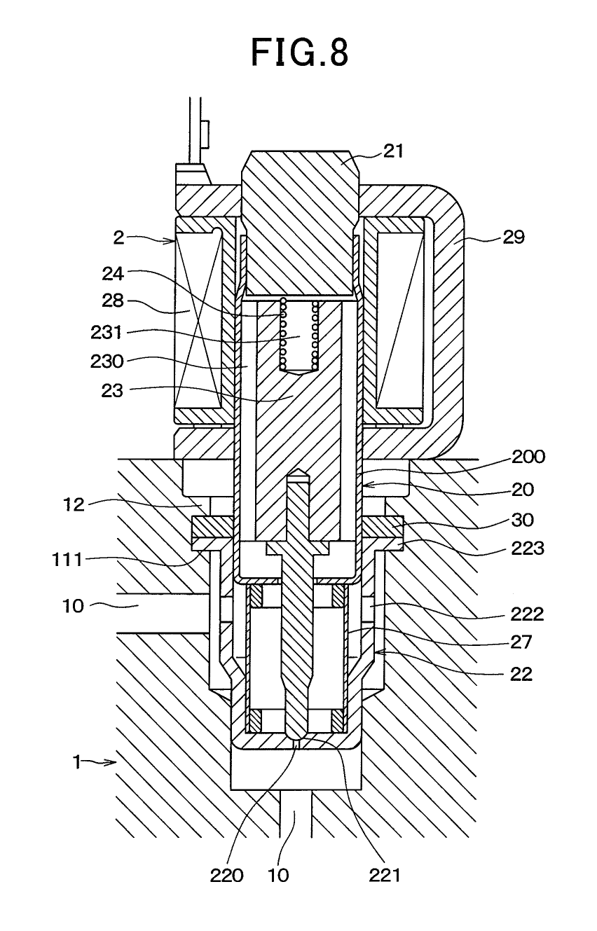

Next, a fourth embodiment of the invention is described with reference to FIG. 8 with a focus on differences with the third embodiment.

As shown in FIG. 8, in this embodiment, the ring 30 as a deformation suppressing member is sandwiched between the valve seat flange part 223 and the swaging deformation portion 12. The ring 30 is made of metal, and has a plate thickness sufficiently larger than that of the valve seat flange part 223 so that its rigidity is sufficiently high. The ring 30 is formed in a disk shape, and abuts against nearly the entire surface on the side of the outer space of the valve seat flange part 223.

Since the load which the braking fluid acts on the valve seat flange part 223 is received by the ring 30 having high rigidity, the valve seat flange part 223 can be prevented or suppressed from being deformed. Accordingly, since the contact pressure at the abutment portion between the valve seat flange part 223 and the bottom portion 111 of the assembling hole 11 can be prevented or suppressed from decreasing, good sealability can be maintained.

The fourth embodiment provides the same advantages as those provided by the third embodiment. In addition, since the valve seat flange part 223 can be prevented or suppressed from being deformed, good seal can be obtained permanently.

It is a matter of course that various modifications can be made to the above embodiments.

Two or more of the above embodiments may be combined if there is no problem in the combination.

The above explained preferred embodiments are exemplary of the invention of the present application which is described solely by the claims appended below. It should be understood that modifications of the preferred embodiments may be made as would occur to one of skill in the art.

What is claimed is:

1. A braking fluid control apparatus comprising:
a housing; and
an electromagnetic valve,
the housing including a fluid passage through which a braking fluid flows, and being formed with an assembling hole which opens to outside of the housing at an open end thereof and has a flat bottom portion,
the electromagnetic valve including:
a cylindrical sleeve inserted in the assembling hole on a side of one end portion thereof;
a coil disposed at an outer periphery of the sleeve on a side of another end portion of the sleeve;
a plunger disposed within the sleeve so as to be movable depending on energization of the coil; and
a valve body for opening and closing the fluid passage in interlock with movement of the plunger,
the sleeve including a disk-shaped flange part projecting radially outward thereof from the side of the one end portion of the sleeve,
the flange part being formed by bending work in a convex shape projecting toward the bottom portion of the assembling hole or a concave shape concaved toward the bottom portion of the assembling hole over an entire periphery thereof, and disposed within the assembling hole,
the flange part being sandwiched between the bottom portion of the assembling hole and a swaging deformation portion formed by swaging an area in the vicinity of the open end of the assembling hole.

2. The braking fluid control apparatus according to claim 1, wherein a deformation suppressing member is sandwiched between the flange part and the swaging deformation portion for suppressing the flange part from being deformed by pressure of the braking fluid.

3. A braking fluid control apparatus comprising:
a housing; and
an electromagnetic valve,
the housing including a fluid passage through which a braking fluid flows, and formed with an assembling hole which opens to outside of the housing at an open end thereof and has a flat bottom portion,
the electromagnetic valve including:
a cylindrical valve seat section inserted in the assembling hole on a side of one end portion thereof, and formed with a valve seat at a bottom portion thereof;
a cylindrical sleeve inserted in the valve seat section on a side of one end portion thereof;
a coil disposed at an outer periphery of the sleeve on a side of another end portion of the sleeve;
a plunger disposed within the sleeve so as to be movable depending on energization of the coil; and
a valve body that opens and closes the fluid passage by sitting on and separating from the valve seat in interlock with movement of the plunger,
the valve seat section including a disk-shaped flange part projecting radially outward thereof from the side of the one end portion thereof,
the flange part being formed by bending work in a convex shape projecting toward the bottom portion of the assembling hole or a concave shape concaved toward the bottom portion of the assembling hole over an entire periphery thereof, and disposed within the assembling hole,
the flange part being sandwiched between the bottom portion of the assembling hole and a swaging deformation portion formed by swaging an area in the vicinity of the open end of the assembling hole.

4. The braking fluid control apparatus according to claim 3, wherein a deformation suppressing member is sandwiched between the flange part and the swaging deformation portion for suppressing the flange part from being deformed by pressure of the braking fluid.
